(19) United States
(12) Patent Application Publication
(10) Pub. No.: US 2016/0355904 A1
(43) Pub. Date: Dec. 8, 2016

(54) Methods for Modifying and Enhancing Material Properties of Additive Manufactured Metallic Parts

(71) Applicants: Ajit Achuthan, Potsdam, NY (US); Joshua D. Gale, Goffstown, NH (US)

(72) Inventors: Ajit Achuthan, Potsdam, NY (US); Joshua D. Gale, Goffstown, NH (US)

(73) Assignee: Clarkson University, Potsdam, NY (US)

(21) Appl. No.: 15/171,619

(22) Filed: Jun. 2, 2016

Related U.S. Application Data
(60) Provisional application No. 62/169,869, filed on Jun. 2, 2015.

(51) Int. Cl. C21D 10/00; B33Y 30/00; B23K 15/00; C22F 3/00; B23K 26/00; B22F 3/105; B22F 3/24; B33Y 10/00; B23K 26/342

(52) U.S. Cl. CPC C21D 10/00; B33Y 10/00; B33Y 30/00; B23K 15/0086; B23K 26/342; B23K 26/0093; B22F 3/1055; B22F 3/24; C22F 3/00; B22F 2003/1056; B22F 2998/10

(57) ABSTRACT

A device for additive manufacturing of an object. The device includes: a first probe configured to form the object; and a work-hardening second probe, where the work-hardening second probe is an ultrasonic probe, and further where the second probe is configured to emit ultrasonic energy to modify a substructure of the object during manufacture; wherein the first probe is configured to increase a temperature of at least a portion of a first layer of the object facing the first probe, to a first depth; and wherein the second probe is configured to work-harden the at least a portion of the first layer of the object facing the first probe, to a second depth, the second depth being greater than the first depth.

### CROSS-REFERENCE TO RELATED APPLICATION

This application claims priority to U.S. Provisional Patent Application Ser. No. 62/169,869, filed on Jun. 2, 2015 and entitled “In-Situ Processes and Methods to Densify, Modify Microstructure, Control Residual Stresses and Enhance Material Properties of Additive Manufactured Metallic Parts by Introducing Local Mechanical Work,” the entire disclosure of which is incorporated herein by reference.

### FIELD OF THE INVENTION

The present disclosure relates generally to 3D printing techniques, and more particularly to methods and systems for engineering the microstructure of 3D printed structures.

### BACKGROUND

3D printing is a term referring to various processes for synthesizing a three-dimensional object. In most 3D printing systems, successive layers of material are deposited by an automated system using a computer running design software. There are innumerable applications for 3D printing.

However, 3D-printed structures are often created without consideration to the substructure or microstructure of the item. This is due, in large part, to the inability of 3D printers to affect the substructure of the item being printed. This level of control is currently not available in existing 3D printers.

Engineering the substructure of a material can influence dislocation dynamics locally, potentially producing enhanced effective mechanical properties. Greater strength and ductility are very desirable mechanical properties and critical in many applications. Enhancing yield strength of the material while maintaining sufficient ductility is a unique advantage that the materials with engineered substructures could achieve when compared to homogeneously work hardened material. The ability to enhance the sintered microstructure will help remedy most of the common metallurgical issues in parts produced using additive manufacturing techniques, porosity, part distortion, delamination and strength; potentially leading to a boost in this area of research and 3-D printer sales.

Accordingly, there is a continued need in the art for methods and devices for engineering the substructure of 3D-printed items.

### SUMMARY OF THE INVENTION

The present disclosure is directed to 3D printing. More specifically, the disclosure is directed to methods and systems for engineering the substructure of 3D-printed items. Materials with engineered 3D substructures have the potential to revolutionize the structural design world. 3D printed parts can be designed based on a material design approach rather than the conventional structural design approach. Engineered materials with 3D substructures can potentially offer any required local mechanical properties to meet the structural requirement of the machine part. Local variation in material properties can be achieved by locally varying the sub structure characteristics.

According to an aspect is a device for additive manufacturing of an object. The device includes a first probe configured to form the object and a work-hardening second probe.

According to an embodiment, the work-hardening second probe is an ultrasonic probe configured to emit ultrasonic energy to modify a substructure of the object during manufacture.

According to an embodiment, the work-hardening second probe comprises a laser configured to emit laser energy to build a substructure in the object during manufacture.

According to an embodiment, the first probe is configured to sinter or melt at least a portion of a first layer of the object facing the first probe, to a first depth. According to an embodiment, the second probe is configured to work-harden at least a portion of the first layer of the object facing the first probe, to a second depth, wherein the second depth is greater than the first depth.

According to an embodiment, the work-hardening enhances multi-material bonding of the object.

According to an embodiment, the work-hardening enhances bonding between deposited layers of the object.

According to an embodiment, the work-hardening reduces distortion and cracking of the object.

According to an aspect is a device for additive manufacturing of an object. The device comprises: a first probe configured to form the object; and a work-hardening second probe, wherein the work-hardening second probe is an ultrasonic probe, and further wherein the second probe is configured to emit ultrasonic energy to modify a substructure of the object during manufacture; wherein the first probe is configured to sinter or melt at least a portion of a first layer of the object facing the first probe, to a first depth; and wherein the second probe is configured to work-harden the at least a portion of the first layer of the object facing the first probe, to a second depth, wherein the second depth is greater than the first depth.

According to an aspect is a method for additive manufacturing of an object. The method includes the steps of: providing a dual-probe additive manufacturing device, the device comprising a first probe configured to form the object and a work-hardening second probe; adding, with the first probe, a layer of the object; and work-hardening, with the second probe, the added layer of the object.

According to an embodiment, the work-hardening step is performed concurrently with the adding step.

These and other aspects and embodiments of the invention will be described in greater detail below, and can be further derived from reference to the specification and figures.

### BRIEF DESCRIPTION OF THE DRAWINGS

The present invention will be more fully understood and appreciated by reading the following Detailed Description in conjunction with the accompanying drawings, in which:

FIG. 1 is a schematic representation of a method and device for modifying the substructure of a 3D-printed device, in accordance with an embodiment.

FIG. 2 is a schematic representation of a sintered 3D-printed item with a line pattern built into the sample using an ultrasonic treatment probe to discretely strengthen the interior of the item, in accordance with an embodiment.

FIG. 3 is a graph of nanoindentation results from a 316L DMLS sample cross-section after ultrasonic treatment, in accordance with an embodiment.

FIG. 4 is a flowchart of a method as described herein, in accordance with an embodiment.

### DETAILED DESCRIPTION OF EMBODIMENTS

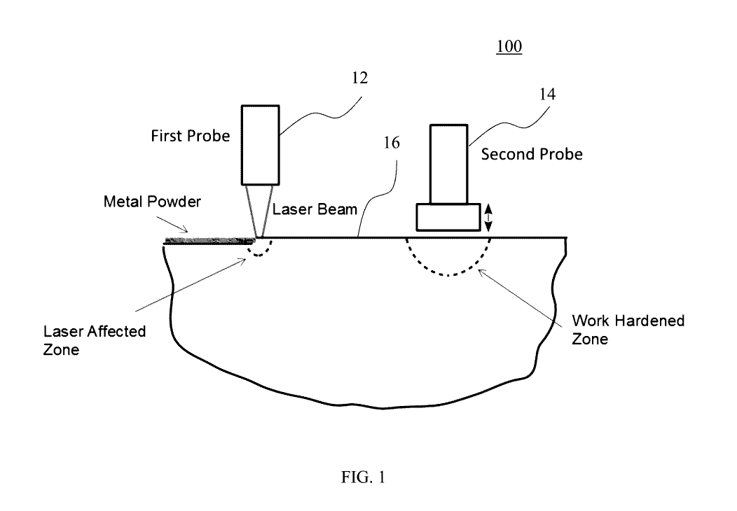

Layer-by-layer fabrication, the key characteristic of additive manufacturing, by its nature provides an opportunity to access the bulk volume and introduce microstructure enhancement processes, processes which are normally limited to the surface in conventional manufacturing techniques. Accordingly, referring now to the drawings, wherein like reference numerals refer to like parts throughout, there is seen in FIG. 1 a schematic representation of a method and device for advantageously altering the microstructure of a 3-D printed object. According to an embodiment, the method, device, and system comprises a two probe system 100. The first probe 12 is a sintering mechanism for creating the object 16. A second probe 14 is a selective work hardening device. According to an embodiment, the second probe 14 utilizes one of multiple possible techniques to produce the plastic deformation necessary to create work hardening, including, but not limited to, ultrasonic and laser energy systems. For example, the second probe 14 can modify and improve material properties locally through ultrasonic densification.

According to an embodiment, the second probe utilizes a technique to strengthen the 3D-printed object during the printing process. Among other benefits, the methods and systems can densify the 3D-printed object, modify the microstructure of the 3D-printed object, control residual stresses of the 3D-printed object, and/or otherwise enhance the material properties of the 3D-printed object. Notably, the 3D-printed object can comprise a wide variety of materials, including plastics, metals, other polymers, and combinations thereof.

According to an embodiment, for example, the functionality of the second probe is utilized to enhance bonding between layers, including densification, enhanced multi-material bonding, mitigation of residual stress and part distortion, in addition to microstructural modification through work-hardening. 3D printed parts contain tensile residual stresses on the exterior surfaces of the part, that can lead to cracking and part distortion, and the process of work-hardening can be used to mitigate the residual stress and reduce distortion and hot cracking, among other potential benefits.

According to an embodiment, therefore, access to the bulk material through layer-by-layer fabrication can be utilized to engineer 3D substructures in multiple ways. One such approach is by introducing work-hardening zones locally as needed. The work-hardening of a material's surface by shot peening is a well-established technique for enhancing the surfaces strength. Increasing the surface strength increases the resistance to crack initiation and environmental degradation that mostly originate at the surface, thereby increasing the durability and fatigue strength of the structure. Using an ultrasonic treatment probe 14 to introduce work-hardening selectively on layers during layer-by-layer fabrication to form a uniformly densified volume of material or to produce engineered 3D substructure, therefore, provides an opportunity to enhance the mechanical properties significantly. More importantly, the densification or 3D substructure formation by selective localized work-hardening may serve as a tool to achieve the desired local properties as precisely as needed for the specific machine part.

Therefore, according to an embodiment of the method, a first sintering or melting process step is followed by a second ultrasonic loading step, concurrently or cyclically with an appropriate time interval, wherein ultrasonic energy is applied in order to introduce work-hardening. The depth of work-hardened zone needs to be sufficient enough, so that the temperature field from the subsequent sintering step won't affect a major portion at the bottom of the work hardened region in the previous layer, thus retaining a sufficient work-hardened zone, as shown in FIG. 1.

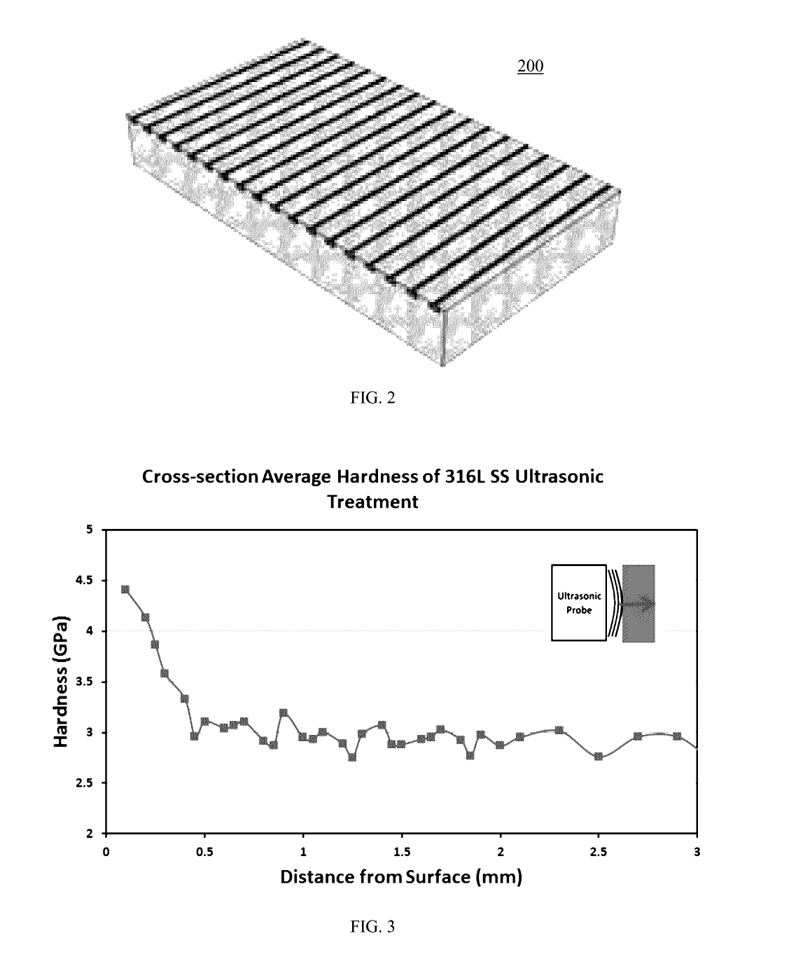

Referring to FIG. 2, in one embodiment, is an example of a 3D-printed item 200 manufactured according to the methods and with the devices as described or otherwise envisioned herein. The item 200 is work-hardened from ultrasonic treatment lines built into the structure to discretely reinforce the interior of the part. The line pattern built into the item 200 using an ultrasonic treatment probe strengthens the interior of the item.

Preliminary work with an ultrasonic welder on a 316L DMLS device produced samples with enhanced material properties such as hardness through the use of ultrasonic energy. After ultrasonic treatment on the surface of the 316L sample, hardness at the surface increased by 46%, as shown in FIG. 3. The graph in FIG. 3 shows hardness data as distance from the treated edge performed on the cross section of the 316L sample. Treatment on multiple layers during part production is expected to increase hardness throughout the entire cross-section.

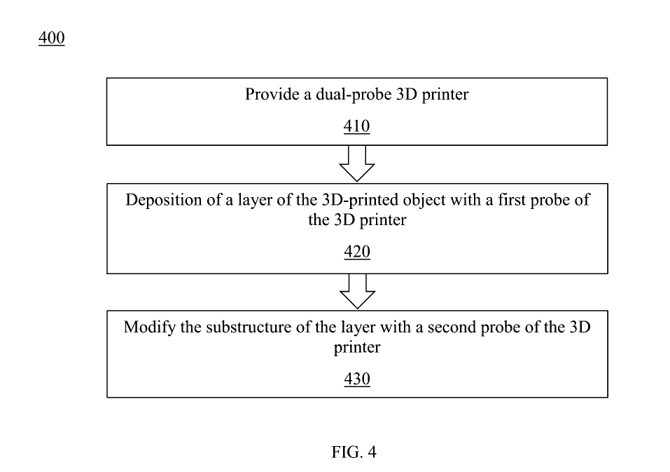

Referring to FIG. 4, in one embodiment, is a method 400 for manufacturing a 3D-printed object. At step 410 of the method, a 3D printer is provided. The 3D printer can be, for example, one of the 3D printers described or otherwise envisioned herein. For example, the 3D printer can be a dual-probe printer in which the first probe 12 is a sintering mechanism for creating the object, and the second probe 14 is a selective work hardening device.

At step 420 of the method, the 3D printer deposits a layer of the object being 3D printed. For example, the first probe of the 3D printer performs a sintering step to create a portion of the object.

At step 430 of the method, the 3D printer modifies the substructure of the object being 3D printed. For example, the second probe of the 3D printer can be a selective work hardening device. Thus, the second probe 14 can utilize one of multiple possible techniques to perform this step of the method, including but not limited to, ultrasonic and laser energy systems. For example, the second probe 14 can modify and improve material properties locally through ultrasonic densification.

According to an embodiment, the work-hardening step is performed concurrently with sintering or melting. According to another embodiment, the work-hardening step is performed intermittently. For example, the work-hardening step can be performed only after a certain number of layers are sintered. The time period between application of work-hardening can be based on the depth of the layers, the number of the layers, the amount of time expired, or on any of a wide variety of other factors.

Although the present invention has been described in connection with a preferred embodiment, it should be understood that modifications, alterations, and additions can be made to the invention without departing from the scope of the invention as defined by the claims.

What is claimed is:

1. A device for additive manufacturing of an object, the device comprising:
a first probe configured to form the object; and
a work-hardening second probe.

2. The device of claim 1, wherein the work-hardening second probe is an ultrasonic probe, and further wherein the second probe is configured to emit ultrasonic energy to modify a substructure of the object during manufacture.

3. The device of claim 1, wherein the work-hardening second probe comprises a laser, and further wherein the second probe is configured to emit laser energy to modify a substructure of the object during manufacture.

4. The device of claim 1, wherein the first probe is configured to form the object through sintering or melting with the aid of a laser beam or electron beam.

5. The device of claim 4, wherein the second probe is configured to work-harden the at least a portion of the first layer of the object facing the first probe, to a second depth, wherein the second depth is equal to or greater than the first depth.

6. The device of claim 1, wherein the work-hardening enhances multi-material bonding of the object.

7. The device of claim 1, wherein the work-hardening enhances bonding between deposited layers of the object.

8. The device of claim 1, wherein the work-hardening reduces distortion, porosity, and cracking of the object.

9. A device for additive manufacturing of an object, the device comprising:
a first probe configured to form the object; and
a work-hardening second probe, wherein the work-hardening second probe is an ultrasonic probe, and further wherein the second probe is configured to emit ultrasonic energy to modify a substructure of the object during manufacture;
wherein the first probe is configured to sinter or melt a portion of a first layer of the object facing the first probe, to a first depth; and wherein the second probe is configured to work-harden the at least a portion of the first layer of the object facing the first probe, to a second depth, wherein the second depth is equal to or greater than the first depth.

10. A method for additive manufacturing of an object, the method comprising the steps of:
providing a dual-probe additive manufacturing device, the device comprising a first probe configured to form the object and a work-hardening second probe;
adding, with the first probe, a layer of the object; and
work-hardening, with the second probe, the added layer of the object.

11. The method of claim 10, wherein the work-hardening step is performed concurrently with the adding step.

12. The method of claim 10, wherein the work-hardening second probe is an ultrasonic probe, and further wherein the second probe is configured to emit ultrasonic energy to build a substructure in the object by work hardening in the form of patterns during manufacture.

13. The method of claim 10, wherein the work-hardening second probe comprises a laser, and further wherein the second probe is configured to emit laser energy to modify a substructure of the object during manufacture.

14. The method of claim 10, wherein the first probe is configured to form the object through sintering or melting with the aid of a laser beam or electron beam.

15. The method of claim 10, wherein the second probe is configured to work-harden the at least a portion of the first layer of the object facing the first probe, to a second depth, wherein the second depth is equal to or greater than the first depth.

16. The method of claim 10, wherein the work-hardening enhances multi-material bonding of the object.

17. The method of claim 10, wherein the work-hardening enhances bonding between deposited layers of the object.

18. The method of claim 10, wherein the work-hardening reduces distortion, porosity and cracking of the object.
